(19) United States
(12) Patent Application Publication
(10) Pub. No.: US 2003/0029327 A1
(43) Pub. Date: Feb. 13, 2003

(54) Metal food-heating tray for microwave oven

(76) Inventor: C. J. Zhu, Bao An (CN)

Correspondence Address: CHRISTIE, PARKER & HALE, LLP, 350 WEST COLORADO BOULEVARD, SUITE 500, PASADENA, CA, 91105, US

(21) Appl. No.: 10/167,777

(22) Filed: Jun. 10, 2002

(30) Foreign Application Priority Data
Aug. 10, 2001 (CN) 01233931.8

(51) Int. Cl. A47J 37/10

(52) U.S. Cl. 99/422

(57) ABSTRACT

A kind of metal food-heating tray for microwave oven comprising a metal tray, characterized by insulating stands that are evenly distributed on the bottom surface of the metal tray. The insulating stands on the bottom surface of the tray effectively detach the metal food-heating tray for microwave oven from the rotating tray of microwave oven to avoid sparks resulting from electric conduction between the two trays. Said metal food-heating tray for microwave oven performs equally as the metal food-heating tray for use with other than microwave oven and may be used together with both non-metal and metal rotating trays in the microwave oven.

### Cross Reference to Related Application

This application claims priority of Chinese Patent Application No. 01233931.8, filed on Aug. 10, 2001.

### Technical Field

The present utility model relates to a tray for microwave oven, especially a kind of metal food-heating tray for microwave oven.

### Background Technology

As a new type of food heater, the microwave oven has been widely used among the consumers. The conventional rotating trays used in microwave ovens are made of glass to facilitate the penetration of microwave. Therefore, non-metal trays are generally used for heating foods with microwave oven. Said non-metal trays are usually thick glass trays or ceramic trays. With the advancement of researches on the heating principle of microwave oven, microwave oven rotating trays made of metallic materials have been put on the market, such as metal enamel rotating trays that are characterized by light weight and strong durability, and can fully satisfy the requirement of application as an auxiliary part of microwave oven in performance. Now that microwave oven can use metal enamel rotating tray, it's undoubted that metal tray also can be used for containing foods. Therefore, metal food-heating trays for microwave oven have appeared in the market. However, it is found that in actual application metal food-heating trays can only be used together with non-metal rotating trays in microwave ovens. If it is used on metal rotating tray, it will cause sparks because of electric conduction between the two trays, and consequently the normal use of microwave oven will be affected.

### Content of the Invention

The present utility model eliminates the defects of the aforementioned metal food-heating trays that cannot be used on metal rotating tray of microwave oven by providing a kind of metal food-heating tray for microwave oven that can be used on non only non-metal rotating tray of microwave oven but also metal rotating tray.

The metal food-heating tray for microwave oven in the present utility model includes a metal tray, whose characteristic is that insulating stands are evenly distributed at the bottom of the metal tray.

Utilizing the insulating stands at the bottom of the tray, the metal food-heating tray for microwave oven in the present utility model is effectively detached from the metal rotating tray of microwave oven to avoid sparks resulting from electric conduction between the two metal trays. Said metal food-heating t:ray for microwave oven performs equally as the metal food-heating tray for use with other than microwave ovens, and it can be used together with both non-metal and metal rotating tray in the microwave oven.

The particular structure of the metal food-heating tray for microwave oven in the present utility model is as shown in the following drawings and embodiment.

### BRIEF DESCRIPTION OF THE DRAWINGS

FIG. 1: Structural schematic drawing of metal food-heating tray for microwave oven;

FIG. 2: Section view of the metal food-heating tray for microwave oven in line A-A of FIG. 1.

### THE PREFERRED EMBODIMENT

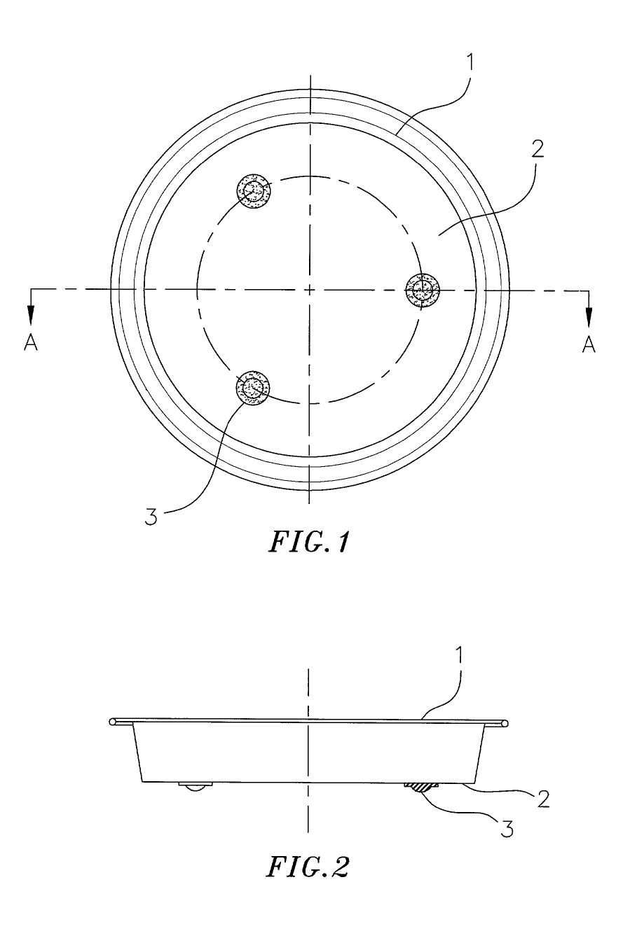

From FIG. 1 and FIG. 2, It is clearly shown that this is a circular metal food-heating tray for microwave oven; there are three insulating stands 3 on the bottom surface 2 of the metal tray 1; the three insulating stands 3 are symmetrically distributed on the bottom surface 2 of the metal tray 1; and the insulating stands 3 are stuck on the metal tray 1 through vulcanization. The said insulating stands 3 are made by rubber.

1. The kind of metal food-heating tray for microwave oven that includes a metal tray, characterized in that insulating stands (3) are evenly distributed on the bottom surface (2) of the metal tray (1).

2. The metal food-heating tray for microwave oven as mentioned in claim 1, characterized in that three insulating stands (3) are symmetrically distributed on the bottom surface (2) of the metal tray (1).

3. The metal food-heating tray for microwave oven as mentioned in claim 1, characterized in that the insulating stands (3) are made by rubber.

4. The metal food-heating tray for microwave oven as mentioned in claim 2, characterized in that the insulating stands (3) are made by rubber.
